(19) United States
(12) Patent Application Publication
(10) Pub. No.: US 2009/0101760 A1
(43) Pub. Date: Apr. 23, 2009

(54) Aircraft engine protection unit (A.E.P.U)

(76) Inventor: Maahnchooh Donald Mundingo Ghogomu, Inglewood, CA (US)

Correspondence Address: Maahnchooh Donald Mundingo Ghogomu, 7130 E. Marshall Pl., Tulsa, OK, 74115, US

(21) Appl. No.: 12/074,196

(22) Filed: May 20, 2008

Related U.S. Application Data
(60) Provisional application No. 60/919,848, filed on Mar. 26, 2007.

(51) Int. Cl. B64D 29/00

(52) U.S. Cl. 244/53 R

(57) ABSTRACT

My present invention relates to a Protective Screen specifically designed to be mounted, anchored or fitted at the front intake of a jet engine nacelle aircraft to prevent the ingestion of birds and other foreign airborne objects of substantial amount(s), size(s), and quantities from entering the engine. The external front view of the Aircraft Engine Protection Unit (AEPU) screen, is a Radial Dome-Shaped Screen with interlocking mesh wires, rods and bars braced or welded together. This screen is anchored to the front external nacelle of the aircraft engine, attached with the aid of I-Bar (Arm) structures fastened on the outside panels securing the AEPU Screen in the front position. A De-icing mechanism is installed to enable defrosting by means of electrical and/or avionics systems incorporated in the AEPU system. Since my invention is at its conceptual stage, the exact dimension(s) of materials and parts produced shall be determined during manufacturing.

### CROSS REFERENCES TO RELATED APPLICATIONS

The present application claims priority to U.S. Provisional Application 60/919,848 filled Mar. 26, 2007 and incorporated here in its entirety by reference.

### TECHNICAL FIELD OF INVENTION

The invention discloses a protective mesh screen or grid work of mesh wires and bars Braced together or welded together and fitted onto the external forward intake cavity of the nacelle of a jet airplane engine. This screen will prevent Foreign Object Debris (FOD) and particularly birds from entering into the engine nacelle.

### BACKGROUND OF THE INVENTION

Foreign object debris (FOD), including birds and other airborne objects as well as humans like an unwary ground personnel have been ingested or sucked into the engine intake cavity of an aircraft during operation. These incidents have resulted to engine malfunctions, engine failures and human injuries and fatalities. Other devices for engine protection have not been satisfactory in protection without compromising engine air intake, thus affecting the aerodynamics and also not provided adequate de-icing. My invention incorporates the aerodynamics of air flow and proper functioning of the engine during operation equipped with adequate de-icing mechanism.

### SUMMARY

The Aircraft Engine Protection Unit-AEPU is a highly structurally and stable protective screen made of mesh wires, rods and bars braced together and mounted on the external front engine nacelle of the aircraft to prevent the ingestion of foreign objects like birds from entering the engine. Thus preventing engine mal-function and engine failure. The AEPU is made of highly stress and corrosion resistant materials (steel/titanium metal) that can tolerate extreme pressure and temperature differentials. The forward tips of the mesh wires, rods and bars are streamlined to a forward narrowed V-Shaped structure to enhance aerodynamics with negligible air resistance. This radial dome-shaped unit consisting of mesh wires, rods and bars that radiate outward from the top center downward from a central point (the grid-hub) to form the circumference of the AEPU Screen. A vivid description of a “globe like” structure of longitudinal and latitudinal lines running across from the top center point of the screen downward to the outer circumferential nacelle of the engine. This is fastened via the two external panels to the aircraft nacelle by I-bars (Arm) joints. The inner AEPU is fastened onto external panel (#2) by means of locked head screws and/or bolts which can be detached during maintenance or replacement. The concentric rings of mesh wires, rods and bars are braced to a minimum spacing between one inch (1 to 14/8 inch) apart for the light, small or medium aircraft categories and two inches (2 to 24/8 inches) apart for each successive member of the heavy or larger aircraft categories. The interlocking spokes/rods/mesh wires running parallel to each other from top to bottom are equally spaced to a minimum, but not limited to 4/8 of an inch 1½ cm for small/medium categories and one (1 inch or 2½ cm for larger/heavy categories. The AEPU can be retrofitted onto existing fleets or installed as original factory equipment at the time jet engines and airliners are manufactured.

### BRIEF DESCRIPTION OF DRAWINGS

FIG. 1 is a radial external side view showing bare panels.

FIG. 2 is a radial external side view of the AEPU showing panels in FIG. 1 with the addition of rivets/screws.

FIG. 3 is a radial external front view showing panels 1 and 2.

FIG. 4 is a pre-assembled radial external front view shown in FIG. 3 (with panels 1 and 2) and added joining I-bars/Arms.

FIG. 5 is a radial front view of panel 2 with interlocking bars and mesh wires.

FIG. 6 is a detailed pre-assembled radial front view showing all essential parts, including the panels and the insertion of the interlocking bars and mesh.

FIG. 7 is a detailed final external radial front view assembly of the AEPU as shown in FIG. 6, now anchored to the aircraft.

FIG. 8 is a detailed final external side view assembly (dome-shaped) structure anchored to the aircraft nacelle.

FIG. 9 illustrates the AEPU Avionics/Electrical de-icing system/circuit.

### DETAILED DESCRIPTION OF THE INVENTION

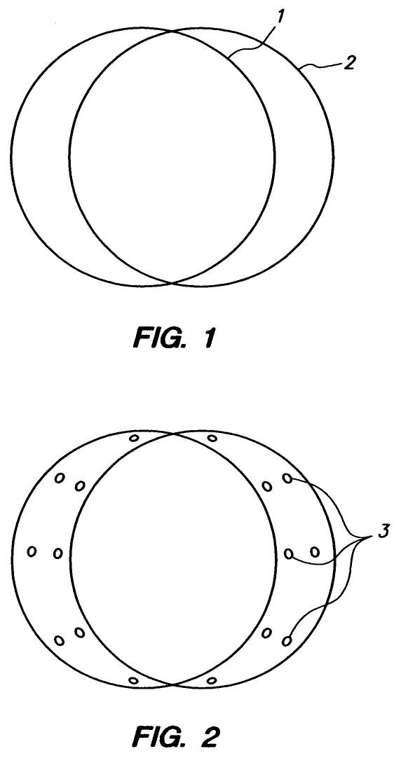

FIG. 1 Shows the radial external skeletal side view consisting of two panels, panel 1 and 2, which represent the structural foundation of the Aircraft Engine Protection Unit-AEPU.

FIG. 2 To these bare skeletal panels shown in FIG. 1 are drilled bores/holes 3, for sub-sequent attachment of rivets/screws/bolts for anchorage on assembly.

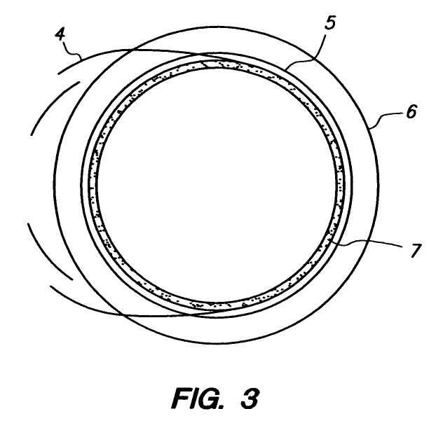

FIG. 3 Shows the radial external front view of previously shown panels 1 and 2 on side view, represented as 5 and 6 respectively in this view. Panels 5 and 6 are pre-assembled to the air-craft nacelle 7 (front view) and overlap the cowling 4 as shown in drawing.

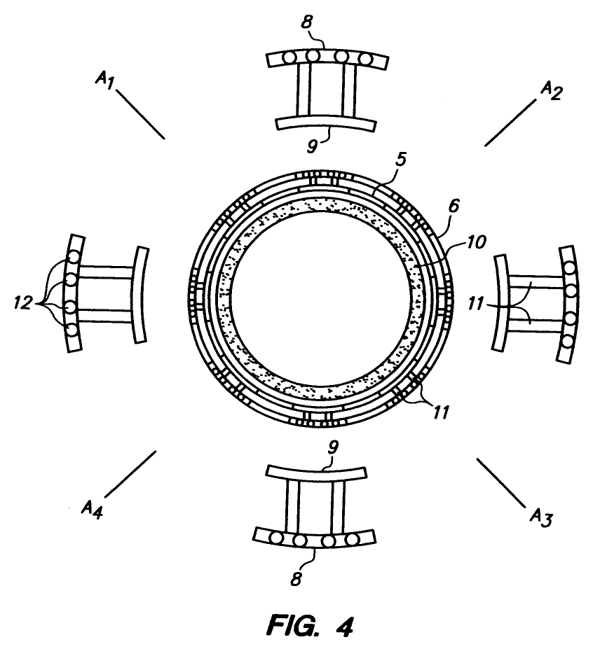

FIG. 4 Shows the front view as in FIG. 3, with panels 5 and 6 attached to the nacelle 10 by I-Bars/Arms 11 in the inner surface 9. The I-Bars 11 outer surface 8 are anchored to the AEPU screen with the aid of rivets/screws/bolts that pass through the rivets/screws/bolts drilled holes 12 for firm attachment.

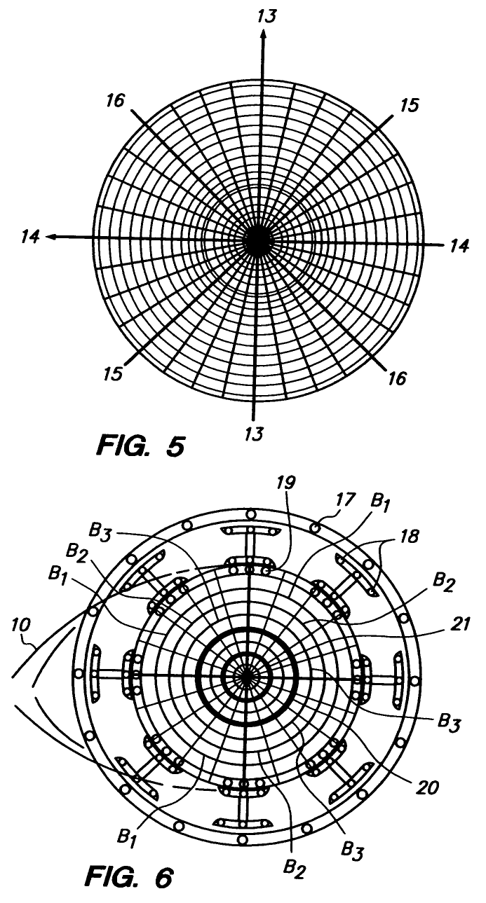

FIG. 5 Shows the radial front structural metal grid mesh of wires, rods and bars braced together in concentric circles and spaced at regular intervals form the central hub of the Aircraft Engine Protection Unit. The mesh is re-enforced by axis bars 13, 14, 15 and 16 to sustain any increased weight and pressure.

FIG. 6 Shows the detailed front view of the pre-assembled AEPU with the entire metal grid consisting of rods/bars B1, B2, B3 held by axis bars and to which are attached electrical wire coils 20 and 21 in the re-enforced circular core for de-icing. The metal grid structure is then anchored to the nacelle 10 by rivets/screws/bolts through drilled holes 19 and to the I-Bars/Arms 11 using rivets/screws/bolts through drilled holes 17 and 18 on the I-bar external surface and Aircraft Engine Protection Unit respectively.

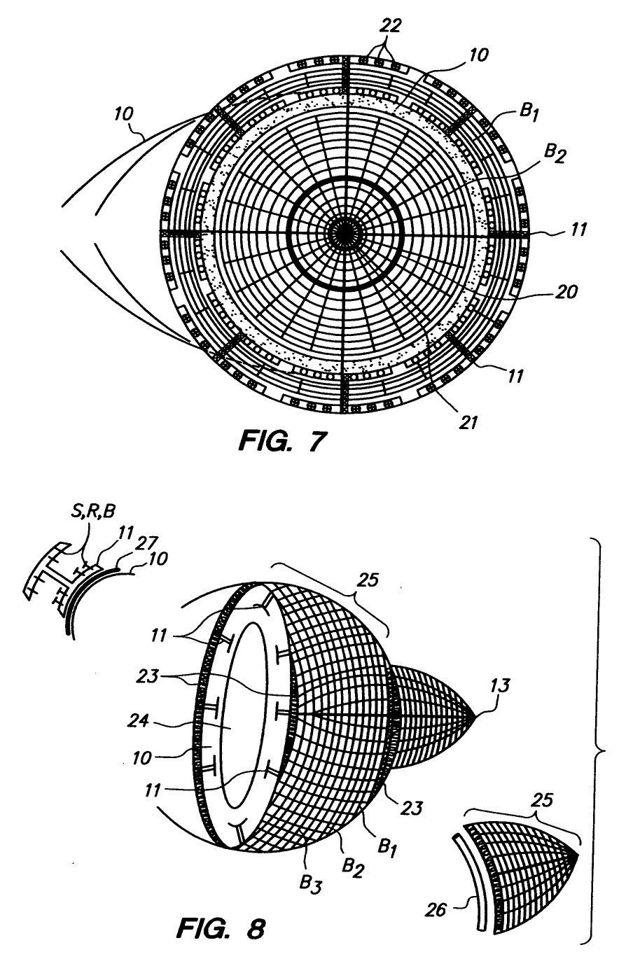

FIG. 7 Illustrates the detailed front view assembly of the AEPU attached to the nacelle 10. The grid mesh B1, B2, B3 . . . are detailed and the joining I-Bars/Arms 11 holding the metal mesh structure in place in conjunction with the axis bars converging to the cores 20 and 21 to hold the electrical de-icing coils 23 as shown in FIG. 8. The outer screen circumference is fastened by detachable screws/bolts on the external panel 6 as mentioned previously in the FIG. 3 front view drawing.

FIG. 8 Illustrates the detailed final external side view assembly of the AEPU which is a dual domed-shaped mesh 25, showing the tip of re-enforced bar axis 13; the electrical coil 23, the dome-shaped metal mesh arranged semi-circularly and concavely as B1, B2, B3 . . . , and attached to the exterior open end of the nacelle 10 by I-Bars/Arms. The rare of the dome is opened to the nacelle cavity 24. The small anterior and the large exterior dome 25, are part of the integral screen structure during manufacture with the tube 26 originally built in or around the screen structure for the electrical coil insertion. The screws/rivets/bolts S, R, B hold the I-bars 11 to the nacelle 10, between which is an insulator 27 that will prevent direct heating of the engine nacelle structure 10 during pro-longed or extreme operations.

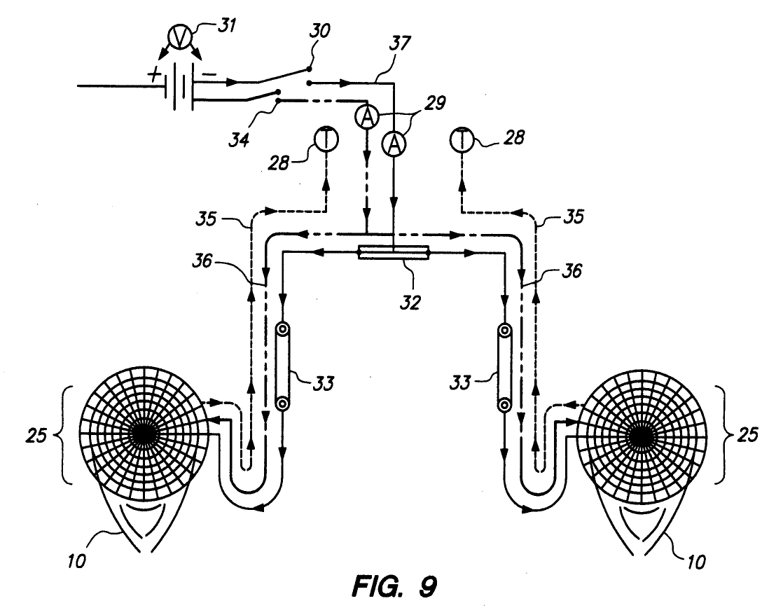

FIG. 9 Shows the Aircraft Engine Protection Unit (AEPU) electrical and de-icing system which consist of the following parts and/or instruments; Ammeter, Voltmeter (if necessary), Temperature gauge(s), Fuses/Circuit breakers/Current Limiter, Emergency Switch Button, Emergency Wiring, Normal Current, Current Distributor.

The metal wires 35, are the temperature wiring cables that are connected by means of preferred fasteners screwed/bolted to the AEPU screen for temperature transmission during operation. The temperature measuring gauge 28, shall be connected to the temperature transmission wire(s) and is installed in the cock-pit for temperature information reading to the flight crew during operation. The electric wire 36, shall automatically transmit or relay current to the AEPU system in the event of any mal-functioning from the normal operating system. This emergency system is a redundancy for the entire functioning system. The wire 37, shall relay through the switch 30 the normal operation of the electrical system with connections at current distributor 32 for current distribution and efficiency. The current transmitted through the system is controlled by a current limiter/fuse/circuit breaker 33, installed for safety purpose. Connected to the emergency circuit system is the emergency switch button 34, which when pushed down will activate the closed circuit for current to be supplied through the system as required. Attached to the circuit system is an ammeter 29.

The electrical wires as seen on FIG. 9, are attached at top central grid region of the semi-dome shaped screen structure. These wire coils are run downward and are inserted in the tube 26 and continues downward to the posterior circumference of the screen where it is inserted in another tube similar to 26, and attached by means of screwed terminals to the end of the screen and connected to the electrical circuit for functioning.

The Aircraft Engine Protection Unit is equipped with an electrical de-icing system, installed for de-icing purpose and should be used in the event of snow/icy conditions encountered during flight operations. The electrical system comprises of the; Power switch (on/off); Thermostastic/temperature control switches; Circuit breakers/fuses; Ammeter (measure current flow); Temperature gauge (monitoring temperature reading at the screen); Temperature wire (measuring of temperature differentials at the screen).

When the power switch button is turned on current flows through the wire and is measured through the ammeter as the electrons flow through the wire to heat up the AEPU system. As the system heats up the temperature wire (tungsten/thermocouple) wire attached at the AEPU warms up and thus transmits heat through the wire to the temperature gauge for reading. The function of the thermostatic or control switch is to control the rate of temperature that may be required to defrost the AEPU Screen at a given time. The function of the circuit breaker or fuse is to control the amount of current that flows through the circuit to heat up the AEPU. This will prevent any circuit damage as a result of current surge or over flow.

The ammeter reading will indicate the amount of current supplied to the system during operation. The ammeter is installed in the cock-pit for monitoring purpose during circuit operation. The power supply source, if necessary may constitute a voltmeter for voltage output measure.

1. The Aircraft Engine Protection Unit is an External Radial Dome-Shaped metal protective screen of grid work mesh wires, rods and bars braced or welded together. This screen will be mounted, attached or fitted with the aid of I-Bars (Arms) structures anchored or riveted on the front external section or area of a jet engine nacelle.

2. The shape of the Aircraft Engine Protective Unit is designed to be structurally stable and to enhance aerodynamics. The AEPU screen will be manufactured in a defined aircraft-specific mode. Meaning that the general concept or principle would be applied with appropriate variation to individual aircraft class(es)/types.

3. The forward edge of the interlocking mesh, rods or bars shall be streamlined to a V-shaped structure at the tips to enhance low air resistance. These interlocking bars, rods and mesh shall be equally spaced out to allow the free flow of air circulation into the engine compartment, but prevent birds and other Foreign Object Debris (FOD) from engine ingestion.

4. FIG. 1 Is a front view radial design panel.

5. FIG. 2 Is a side view radial design panel.

6. FIG. 3 Is the radial external front view of previous panels 1 and 2 of side view, now shown as panels 5 and 6 pre-assembling to the aircraft nacelle 7 and overlap the cowling 4.

7. FIG. 4 Is the front view panels 5 and 6 fastened on aircraft nacelle by means of I-Bars structures 11, riveted, screwed or bolted on aircraft nacelle 10. The I-bar surface 8, will attach the screen and the inner I-bar surface 9 will be attached on nacelle 10.

8. FIG. 5 Is the radial front view metal grid mesh wires, rods, bars braced or welded together in concentric circles and spaced at regular intervals from the central hub of the AEPU, Re-enforced by I-bars 13, 14, 15, 16.

9. FIG. 6 Is a radial front view of the pre-assembled AEPU, with the entire metal grid work Structure and an attachment of the electrical wiring de-icing coil mechanism inserted at circular core regions 20 and 21.

10. FIG. 7 Is the final front view detailed assembled Aircraft Engine Protection Unit Screen.

11. FIG. 8 Is the detailed final external side-view assembly of the AEPU, which is a dual dome-shaped structure 25. Represented re-enforced bar axis 13 and interlocking mesh wires/rods B1, B2, B3 etc. . . . Attached between the nacelle 10 and I-bar panel attachment 5 is a heat insulator.

12. FIG. 9 Illustrate the entire electrical circuit system designed for de-icing of the AEPU metal screen during ground and flight operations. Final number of claims mentioned in the invention are 12 (twelve), 9 (nine) figures listed, total number of drawings 11 (eleven), number of drawing sheets 6 (six) and 10 (ten) description sheets.
